(19) United States
(12) Patent Application Publication
(10) Pub. No.: US 2023/0378436 A1
(43) Pub. Date: Nov. 23, 2023

(54) LITHIUM SECONDARY BATTERY

(71) Applicant: TeraWatt Technology K.K., Yokohama-shi (JP)

(72) Inventors: Ken Ogata, Yokohama-shi (JP); Hiroshi Imoto, Yokohama-shi (JP); Masatsugu Nakano, Yokohama-shi (JP)

(73) Assignee: TeraWatt Technology K.K., Yokohama-shi (JP)

(21) Appl. No.: 18/365,348

(22) Filed: Aug. 4, 2023

Related U.S. Application Data
(63) Continuation of application No. PCT/JP2021/004531, filed on Feb. 8, 2021.

(51) Int. Cl. H01M 4/133; H01M 10/052; H01M 10/0585; H01M 4/36; H01M 50/449; H01M 50/431; H01M 50/489

(52) U.S. Cl. CPC H01M 4/133; H01M 10/052; H01M 10/0585; H01M 4/366; H01M 50/449; H01M 50/431; H01M 50/489; H01M 2004/027

(57) ABSTRACT

An object of the present invention is to provide a lithium secondary battery having a high energy density and excellent in cycle characteristics. The present invention relates to a lithium secondary battery including a positive electrode, a negative electrode not having a negative-electrode active material, a separator placed between the positive electrode and the negative electrode, a carbon metal composite layer formed on a surface of the negative electrode facing the separator, and a conductive thin film formed on a surface of the separator facing the negative electrode, in which the carbon metal composite layer includes a plurality of fibrous carbon materials, each of which are randomly oriented.

### CROSS REFERENCE TO RELATED APPLICATION

This application is a continuation of International Patent Application No. PCT/JP2021/004531, entitled “LITHIUM SECONDARY BATTERY”, filed on Feb. 8, 2021, the entire contents of which are incorporated by reference.

### TECHNICAL FIELD

The present invention relates to a lithium secondary battery.

### BACKGROUND ART

In recent years, a technology of converting natural energy such as solar light or wind power into electric energy has attracted attentions. Under such a situation, various secondary batteries have been developed as a highly-safe power storage device capable of storing a lot of electric energy.

Among them, lithium secondary batteries which perform charge/discharge by transferring lithium ions between a positive electrode and a negative electrode are known to exhibit a high voltage and a high energy density. As the typical lithium secondary battery, a lithium ion secondary battery which contains an active material capable of retaining a lithium element in the positive electrode and the negative electrode, and which charges/discharges by delivering or receiving lithium ions between the positive-electrode active material and the negative-electrode active material is known.

In addition, for the purpose of realizing high energy density, there has been developed a lithium secondary battery in which lithium metal is used as the negative-electrode active material, instead of a material into which the lithium element is able to be inserted, such as a carbon-based material. For example, Patent Document 1 discloses a lithium secondary battery including an ultra-thin lithium metal anode, in order to realize a volume energy density exceeding 1,000 Wh/L and/or a mass energy density exceeding 350 Wh/kg at the time of discharge at least a rate of 1 C at room temperature. Patent Document 1 discloses that, in such a lithium secondary battery, charge is performed by a direct deposition of new lithium metal on the lithium metal as the negative-electrode active material.

In addition, for the purpose of further improving high energy density, productivity, or the like, a lithium secondary battery in which a negative-electrode active material is not used has been developed. For example, Patent Document 2 discloses a lithium secondary battery including a positive electrode, a negative electrode, and a separation membrane and an electrolyte interposed therebetween. In the negative electrode, metal particles are formed on a negative electrode current collector and transferred from the positive electrode, when the battery is charged, to form lithium metal on the negative electrode current collector in the negative electrode. Patent Document 2 discloses that such a lithium secondary battery shows the possibility of providing a lithium secondary battery which has overcome the problem due to the reactivity of the lithium metal and the problem caused during assembly and therefore has improved performance and service life.

### PATENT DOCUMENTS

Patent Document 1: Published Japanese Translation of PCT application No. 2019-517722
Patent Document 2: Published Japanese Translation of PCT application No. 2019-537226

### BRIEF SUMMARY OF THE INVENTION

### Technical Problem

However, the present inventors studied batteries in the prior art including those described in the above patent documents, and found that at least either one of their energy density and cycle characteristic is insufficient.

For example, in the lithium secondary battery that includes a negative electrode containing a negative-electrode active material, due to a volume or mass occupied by the negative-electrode active material, it is difficult to sufficiently increase the energy density and a capacity. In addition, even in an anode-free lithium secondary battery which includes a negative electrode not having a negative-electrode active material, in the one in the prior art, due to repeated charging/discharging, dendritic lithium metal is likely to be formed on a surface of the negative electrode, and a short circuit and a decrease in capacity are likely to be caused, and thus cycle characteristics are insufficient.

In addition, the anode-free lithium secondary battery, a method of applying a large physical pressure on a battery to keep an interface between a negative electrode and a separator at high pressure has also been developed in order to suppress a discrete (non-uniform) growth at the time of lithium metal deposition. However, since application of such a high pressure needs a large mechanical mechanism, as the whole battery, a mass and a volume increase and energy density decreases.

The present invention has been made in consideration of the problems and an object of the present invention is to provide a lithium secondary battery having a high energy density and excellent in cycle characteristics.

### Solution to Problem

A lithium secondary battery according to one embodiment of the present invention includes a positive electrode, a negative electrode not having a negative-electrode active material, a separator placed between the positive electrode and the negative electrode, a carbon metal composite layer formed on a surface of the negative electrode facing the separator, and a conductive thin film formed on a surface of the separator facing the negative electrode, in which the carbon metal composite layer includes a plurality of fibrous carbon materials, each of which are randomly oriented.

Since such a lithium secondary battery does not have a negative-electrode active material, the volume and mass of the entire battery are decreased as compared with a lithium secondary battery having a negative-electrode active material, and the energy density of the lithium secondary battery is high in principle. In such a battery, charging and discharging are performed by depositing lithium metal on a surface of the negative electrode and electrolytically dissolving the deposited lithium metal.

In addition, such a carbon metal composite layer has high and uniform electrical conductivity due to the fact that the fibrous carbon materials are entangled with each other to form a three-dimensional network structure, and an electric potential on the negative electrode surface is able to be made uniform. In addition, since the carbon metal composite layer as a whole contains a carbon material that is able to be a starting point of lithium metal deposition, there are more starting points of lithium metal deposition than the negative electrode, which is a metal electrode, and non-uniform growth of the lithium metal in the lithium secondary battery is suppressed. In addition, in the lithium secondary battery, by forming a conductive thin film on the surface of the separator facing the negative electrode, an electric potential is applied to the deposited lithium metal from both the negative electrode side and the conductive thin film side. Therefore, in such a lithium secondary battery, non-uniform reaction of the lithium metal is further suppressed, and uniform lithium metal is easily deposited on the surface of the negative electrode. That is, the growth of the lithium metal into dendrite form on the negative electrode is suppressed, and the cycle characteristics of the lithium secondary battery are excellent.

Instead of the separator, a solid electrolyte may be used. In such a mode, since a lithium secondary battery is able to be set as a solid battery, it is possible to obtain a lithium secondary battery with higher safety.

An average fiber diameter of the fibrous carbon material is preferably 2 nm or more and 500 nm or less. In such a mode, the three-dimensional network structure of the fibrous carbon material is more likely to be formed, and thus the lithium secondary battery has further excellent cycle characteristics.

An average ratio of a fiber length to a fiber diameter of the fibrous carbon material is preferably 20 or more and 5,000 or less. In such a mode, the three-dimensional network structure of the fibrous carbon material is more likely to be formed, and thus the lithium secondary battery has further excellent cycle characteristics.

The fibrous carbon material may be at least one selected from the group consisting of single-wall carbon nanotubes, multi-wall carbon nanotubes, and carbon nanofibers.

A ratio of a volume occupied by the fibrous carbon material in the carbon metal composite layer is preferably 0.1% or more and 50.0% or less. In such a mode, an electric field occurring on the surface of the negative electrode becomes more uniform, and the growth of lithium metal into dendrite form on the negative electrode is further suppressed.

A thickness of the carbon metal composite layer is preferably 5 nm or more and 5,000 nm or less. In such a mode, an electric field occurring on the surface of the negative electrode becomes more uniform, and the growth of lithium metal into dendrite form on the negative electrode is further suppressed.

The carbon metal composite layer preferably contains at least one metal selected from the group consisting of Sn, Zn, Bi, Ag, In, Pb, and Al. In such a mode, the carbon metal composite layer has more improved affinity with lithium, so that peeling-off of the lithium metal deposited on the negative electrode is further suppressed.

The negative electrode is preferably an electrode consisting of at least one selected from the group consisting of Cu, Ni, Ti, Fe, other metals that do not react with Li, alloys thereof, and stainless steel (SUS). In such a mode, the negative electrode becomes more excellent in safety and productivity because lithium metal having high flammability for manufacturing may not be necessarily needed. In addition, such a negative electrode is stable and therefore, the secondary battery has cycle characteristics improved.

In the lithium secondary battery comprising the negative electrode not having a negative-electrode active material, lithium metal is not formed on the surface of the negative electrode before initial charge. Therefore, the lithium secondary battery has excellent safety and productivity because lithium metal having high flammability for manufacturing may not be used.

The lithium secondary battery preferably has an energy density of 350 Wh/kg or more.

The positive electrode may have a positive-electrode active material.

The conductive thin film may be a thin film consisting of carbon, a thin film consisting of metal or an alloy, or a stacked film thereof.

A film thickness of the conductive thin film is preferably 1 μm or less. In such a mode, the ionic conductivity of the separator tends to be sufficiently maintained.

### Effect of Invention

According to the present invention, it is possible to provide a lithium secondary battery having high energy density and excellent cycle characteristics.

### BRIEF DESCRIPTION OF DRAWINGS

FIG. 1 is a schematic cross-sectional view of a lithium secondary battery according to First embodiment.

FIGS. 2A and 2B are schematic cross-sectional views illustrating a mode of deposition of lithium metal on a surface of a negative electrode in a lithium secondary battery, in which FIG. 2A illustrates a mode of deposition of lithium metal on a surface of a negative electrode in a lithium secondary battery in the prior art, and FIG. 2B illustrates a mode of deposition of lithium metal on a surface of a negative electrode in a lithium secondary battery of the present embodiment.

FIG. 3 is a schematic cross-sectional view of a use of a lithium secondary battery according to First Embodiment.

FIG. 4 is a schematic cross-sectional view of a lithium secondary battery according to Second Embodiment.

FIG. 5 shows the results of measuring each physical property value of the fibrous carbon material in the carbon metal composite layer.

FIG. 6 shows the results of measuring each physical property value of the fibrous carbon material in the carbon metal composite layer.

FIG. 7 shows the results of obtaining a lithium secondary battery having a metal layer composed of the metals shown in the table formed on the negative electrode instead of the carbon metal composite layer and the conductive thin film not formed.

### DETAILED DESCRIPTION

Hereinafter, embodiments of the present invention (hereinafter, referred to as “present embodiment”) will be described in detail with reference to the drawings depending on the necessity. In the drawings, the same element will be represented by the same reference numeral and an overlapping description will be omitted. Unless otherwise specifically described, the positional relationship such as vertical or horizontal one will be based on the positional relationship illustrated in the drawings. Further, a dimensional ratio in the drawings is not limited to the ratio illustrated in the drawings.

### First Embodiment

### Lithium Secondary Battery

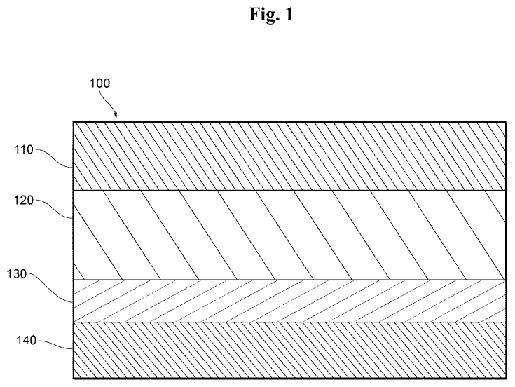

FIG. 1 is a schematic cross-sectional view of a lithium secondary battery according to First Embodiment. As illustrated in FIG. 1, a lithium secondary battery 100 of First Embodiment includes a positive electrode 110, a negative electrode 140 not having a negative-electrode active material, a separator 120 placed between the positive electrode 110 and the negative electrode 140, and a carbon metal composite layer 130 formed on a surface of the negative electrode 140 facing the separator 120. A conductive thin film (not illustrated in FIG. 1) is formed on a surface of the separator 120 facing the negative electrode 140.

Hereinafter, each structure of the lithium secondary battery 100 will be described.

### Negative Electrode

The negative electrode 140 does not have a negative-electrode active material, that is, does not have lithium metal and an active material which serves as a host for lithium (lithium metal or ion). Therefore, in the lithium secondary battery 100, the volume and mass of the entire battery are reduced as compared with a lithium secondary battery including a negative electrode having a negative-electrode active material, and the energy density is high in principle. Here, in the lithium secondary battery 100, charging and discharging are performed by depositing lithium metal on a surface of the negative electrode 140 and electrolytically dissolving the deposited lithium metal.

In the present specification, the term “the lithium metal is deposited on a surface of the negative electrode” means that lithium metal is deposited on at least one of a surface of the negative electrode, a surface of the carbon metal composite layer formed on the surface of the negative electrode, and a surface of a solid electrolyte interface (SEI) layer, which will be described later, formed on the surface of the negative electrode and/or the carbon metal composite layer. In the lithium secondary battery of the present embodiment, the lithium metal is considered to be mainly deposited on the surface of the carbon metal composite layer or the surface of the SEI layer formed on the surface of the carbon metal composite layer, but a location on which the lithium metal is deposited is not limited thereto. Therefore, in the lithium secondary battery 100, the lithium metal may be deposited, for example, on the surface of the negative electrode 140 (the interface between the surface of the negative electrode 140 and the surface of the carbon metal composite layer 130) or deposited on the surface of the carbon metal composite layer 130 (the interface between the carbon metal composite layer 130 and the separator 120).

In the present specification, the term “negative-electrode active material” is a material that causes an electrode reaction, that is, an oxidation reaction and a reduction reaction at the negative electrode. Specifically, examples of the negative-electrode active material of the present embodiment include lithium metal and a host material for a lithium element (lithium ion or lithium metal). The host material for the lithium element means a material provided to retain the lithium ions or the lithium metal in the negative electrode. Such a retaining mechanism is not particularly limited and examples thereof include intercalation, alloying, occlusion of metal clusters, and the like, and intercalation and allowing are typically used.

Such a negative-electrode active material is not particularly limited and examples thereof include lithium metal, an alloy containing lithium metal, a carbon-based material, a metal oxide, a metal alloyed with lithium, an alloy containing the metal, and the like. The carbon-based material is not particularly limited and examples include graphene, graphite, hard carbon, mesoporous carbon, carbon nanotube, carbon nanohorn, and the like. The metal oxide is not particularly limited and examples thereof include a titanium oxide-based compound, a tin oxide-based compound, a cobalt oxide-based compound, and the like. Examples of the metal alloyed with lithium include silicon, germanium, tin, lead, aluminum, gallium, and the like.

In the present specification, the phrase that “the negative electrode does not have a negative-electrode active material” means that a content of a negative-electrode active material in the negative electrode is 10 mass % or less based on a total amount of the negative electrode. The content of the negative-electrode active material in the negative electrode is preferably 5.0 mass % or less, may be 1.0 mass % or less, may be 0.1 mass % or less, or may be 0.0 mass % or less based on the total amount of the negative electrode. Since the negative electrode does not contain the negative-electrode active material or the content of the negative-electrode active material in the negative electrode is within the above-described range, the energy density of the lithium secondary battery 100 is high. The matter that the content of the negative-electrode active material is 0.0 mass % or less means that the negative-electrode active material is not measured in two significant figures.

More specifically, in the negative electrode 140, regardless of a state of charge of the battery, the content of the negative-electrode active material other than the lithium metal is 10 mass % or less, preferably 5.0 mass % or less, or may be 1.0 mass % or less, may be 0.1 mass % or less, or may be 0.0 mass % or less based on the total amount of the negative electrode. In addition, in the negative electrode 140, before initial charge and/or at the end of discharge, a content of the lithium metal is 10 mass % or less, preferably 5.0 mass % or less, may be 1.0 mass % or less, may be 0.1 mass % or less, or may be 0.0 mass % or less based on the total amount of the negative electrode.

In the negative electrode 140, before initial charge and at the end of discharge, a content of the lithium metal may be 10 mass % or less (preferably 5.0 mass % or less, may be 1.0 mass % or less, may be 0.1 mass % or less, or may be 0.0 mass % or less) based on the total amount of the negative electrode; before initial charge or at the end of discharge, the content of the lithium metal may be 10 mass % or less (preferably 5.0 mass % or less, may be 1.0 mass % or less, may be 0.1 mass % or less, or may be 0.0 mass % or less) based on the total amount of the negative electrode; before initial charge, the content of the lithium metal may be 10 mass % or less (preferably 5.0 mass % or less, may be 1.0 mass % or less, may be 0.1 mass % or less, may be 0.0 mass % or less) based on the total amount of the negative electrode; or at the end of discharge, the content of the lithium metal may be 10 mass % or less (preferably 5.0 mass % or less, may be 1.0 mass % or less, may be 0.1 mass % or less, or may be 0.0 mass % or less) based on the total amount of the negative electrode.

In the present specification, the “lithium secondary battery including a negative electrode not having a negative-electrode active material” means that the negative electrode does not have a negative-electrode active material before initial charge or at the end of discharge of the battery. Therefore, the phrase “negative electrode not having a negative-electrode active material” may be rephrased as “negative electrode not having a negative-electrode active material before initial charge or at the end of discharge of the battery”, “negative electrode that does not have a negative-electrode active material other than lithium metal regardless of the state of charge of the battery and does not have the lithium metal before initial charge or at the end of discharge”, “negative electrode current collector not having a lithium metal before initial charge or at the end of discharge of the battery”, or the like. In addition, the “lithium secondary battery including a negative electrode not having a negative-electrode active material” may be rephrased as an anode-free lithium battery, a zero anode lithium battery, or an anodeless lithium battery.

From this standpoint, the lithium secondary battery of the present embodiment is able to be said to have a different structure from lithium ion batteries (LIB) or lithium metal batteries (LMB) in the prior art. Here, the lithium ion battery means a lithium battery containing a host material in the negative electrode to retain a lithium element in the negative electrode, and the lithium metal battery means a lithium battery having lithium metal foil in the negative electrode before initial charge (at the time of assembly of the battery).

In the present specification, the “before initial charge” of the battery means a state from the time of assembly of the battery to the time of first charge. In addition, “at the end of discharge” of the battery means a state in which a voltage of the battery is 1.0 V or more and 3.8 V or less (preferably 1.0 V or more and 3.0 V or less).

In the lithium secondary battery 100, in a case where the voltage of the battery is 1.0 V or more and 3.5 V or less, the content of the lithium metal may be 10 mass % or less (preferably 5.0 mass % or less, may be 1.0 mass % or less, may be 0.1 mass % or less, or may be 0.0 mass % or less) based on the total amount of the negative electrode; in a case where the voltage of the battery is 1.0 V or more and 3.0 V or less, the content of the lithium metal may be 10 mass % or less (preferably 5.0 mass % or less, may be 1.0 mass % or less, may be 0.1 mass % or less, or may be 0.0 mass % or less) based on the total amount of the negative electrode; or in a case where the voltage of the battery is 1.0 V or more and 2.5 V or less, the content of the lithium metal may be 10 mass % or less (preferably 5.0 mass % or less, may be 1.0 mass % or less, may be 0.1 mass % or less, or may be 0.0 mass % or less) based on the total amount of the negative electrode.

In addition, in the lithium secondary battery 100, a ratio M_{3.0}/M_{4.2} of a mass M_{3.0} of lithium metal deposited on the negative electrode 140 in a state in which the voltage of the battery is 3.0 V to a mass M_{4.2} of lithium metal deposited on the negative electrode 140 in a state in which the voltage of the battery is 4.2 V is preferably 20% or less, more preferably 15% or less, and further more preferably 10% or less. The ratio M_{3.0}/M_{4.2} may be 8.0% or less, may be 5.0% or less, may be 3.0% or less, or may be 1.0% or less.

In a typical lithium secondary battery, a capacity of the negative electrode (capacity of the negative-electrode active material) is set to be approximately the same as the capacity of the positive electrode (capacity of the positive-electrode active material), but in the lithium secondary battery 100, charging and discharging are performed by depositing lithium metal on the negative electrode 140 and electrolytically dissolving the deposited lithium metal, and thus there is no need to define the capacity of the negative electrode. Therefore, since the lithium secondary battery 100 is not limited by the charge capacity due to the negative electrode, the energy density is able to be increased in principle. In the lithium secondary battery 100, the carbon metal composite layer 130 is formed on the surface of the negative electrode 140, and the carbon metal composite layer may include a metal and/or carbon material capable of reacting with lithium, while the capacity is sufficiently smaller than that of the positive electrode, and thus the lithium secondary battery 100 is able to be said to “include a negative electrode not having a negative-electrode active material”.

The total capacity of the negative electrode 140 and the carbon metal composite layer 130 is sufficiently small relative to the capacity of a positive electrode 110, and may be, for example, 20% or less, 15% or less, 10% or less, or 5% or less. Each capacity of the positive electrode 110, the negative electrode 140, and the carbon metal composite layer 130 is able to be measured by a known method in the prior art.

The negative electrode 140 is not particularly limited insofar as the negative electrode does not have a negative-electrode active material and is usable as a current collector, and examples include electrodes consisting of at least one selected from the group consisting of Cu, Ni, Ti, Fe, and other metals that do not react with Li, alloys thereof, and stainless steels (SUS). In a case where a SUS is used as the negative electrode 140, a variety of known SUSs in the prior art is able to be used as its kind. One or more of the negative electrode materials may be used either singly or in combination. The term “metal that does not react with Li” in the present specification means a metal which does not form an alloy under the operation conditions of the lithium secondary battery, reacting with lithium ion or lithium metal.

The negative electrode 140 preferably consists of at least one selected from the group consisting of Cu, Ni, Ti, Fe, alloys therewith, and stainless steels (SUS), and more preferably consists of at least one selected from the group consisting of Cu, Ni, alloys therewith, and stainless steels (SUS). The negative electrode 140 is further more preferably Cu, Ni, alloys therewith, or stainless steels (SUS). When such a negative electrode is used, the energy density and productivity of the battery tend to be further improved.

The negative electrode 140 is an electrode not containing lithium metal. Therefore, the negative electrode 140 is able to be manufactured without using a highly flammable and highly reactive lithium metal, so that the lithium secondary battery 100 has excellent safety, productivity, and cycle characteristics.

An average thickness of the negative electrode 140 is preferably 4 μm or more and 20 μm or less, more preferably 5 μm or more and 18 μm or less, and further more preferably 6 μm or more and 15 μm or less. In such a mode, since a volume occupied by the negative electrode 140 in the lithium secondary battery 100 decreases, the lithium secondary battery 100 has a more improved energy density.

### Carbon Metal Composite Layer

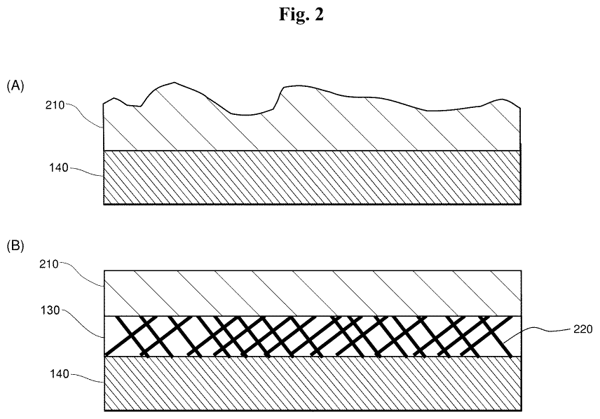

FIGS. 2A and 2B are schematic cross-sectional views illustrating a mode of deposition of lithium metal on a surface of a negative electrode in a lithium secondary battery. FIG. 2A illustrates a mode of deposition of the lithium metal on the surface of the negative electrode in the lithium secondary battery in the prior art, and FIG. 2B illustrates a mode of deposition of the lithium metal on the surface of the negative electrode in the lithium secondary battery of the present embodiment.

As illustrated in FIG. 2A, in the lithium secondary battery in the prior art, it is difficult for lithium metal 210 which is deposited on the surface of the negative electrode 140 to grow uniformly in a plane direction, and as a result, the lithium metal which is deposited on the surface of the negative electrode is likely to grow into dendrite form and the battery has inferior cycle characteristics. On the other hand, as illustrated in FIG. 1, in the lithium secondary battery 100 of First Embodiment, a carbon metal composite layer 130, which is a composite layer containing a carbon material and a metal material, is formed on the surface of the negative electrode 140, and the carbon metal composite layer 130 includes a plurality of randomly oriented fibrous carbon materials as carbon materials. In such a lithium secondary battery of the present embodiment, as illustrated in FIG. 2B, in the carbon metal composite layer 130, a fibrous carbon material 220 is entangled with each other to form a three-dimensional network structure. It is considered that the fibrous carbon material 220 having the three-dimensional network structure makes electrical conductivity of the entire carbon metal composite layer 130 high and uniform, and makes an electric field generated on the surface of the carbon metal composite layer 130 uniform in the plane direction. In addition, the carbon metal composite layer as a whole has a carbon material that is able to act as a starting point for lithium metal deposition. As a result, since the reactivity of the deposition reaction of the lithium metal becomes more uniform on the surface of the carbon metal composite layer 130 irrespective of the location, it is considered that, as illustrated in FIG. 2B, in the lithium secondary battery of the present embodiment, the lithium metal 210 uniformly grown in the plane direction is deposited on the surface of the carbon metal composite layer 130, and the growth of the lithium metal into dendrite form is suppressed. However, the reason why the lithium secondary battery of the present embodiment has excellent cycle characteristics is not limited to the above. In FIG. 2B, the lithium metal 210 may be deposited at an interface between the negative electrode 140 and the carbon metal composite layer 130.

In the present specification, the term “the growth of the lithium metal into dendrite form is suppressed” means that the lithium metal formed on the surface of the negative electrode is suppressed to grow into dendrite form by charge/discharge of the lithium secondary battery or repetition thereof. In other words, it means that the lithium metal formed on the surface of the negative electrode by charge/discharge of the lithium secondary battery or repetition thereof is induced to grow into non-dendrite form. Here, the “non-dendrite form” is not particularly limited and it typically means a plate, valley, or hill form.

The fibrous carbon material contained in the carbon metal composite layer 130 is not particularly limited insofar as it is a material known as a fibrous carbon material among those skilled in the art. From a standpoint that a three-dimensional network structure of the fibrous carbon material is further easily formed, an average fiber diameter of the fibrous carbon material is preferably 2 nm or more and 500 nm or less. From the same standpoint, the average fiber diameter of the fibrous carbon material is more preferably 5 nm or more and 300 nm or less, further more preferably 5 nm or more and 100 nm or less, and even further more preferably 7 nm or more and 80 nm or less.

The average fiber diameter of the fibrous carbon material is able to be measured by a known measurement method, for example, is able to be measured by a scanning electron microscope (SEM) or a transmission electron microscope (TEM). More specifically, before the carbon metal composite layer is formed, the fibrous carbon material used for manufacturing the carbon metal composite layer is observed by SEM or TEM, and the fiber diameter of the fibrous carbon material is able to be measured by visual inspection or image analysis software from the obtained image. The average fiber diameter is calculated by calculating the average (arithmetic mean) of the fiber diameters obtained as described above, and the number n of fibers to be measured is 3 or more, preferably 5 or more, and further more preferably 10 or more.

Measurement of the average fiber diameter of the fibrous carbon material may be performed by observing the fibrous carbon material in the formed carbon metal composite layer. In a case of observing the fibrous carbon material in the formed carbon metal composite layer, the following should be done. For example, the lithium secondary battery 100 may be cut in a thickness direction, the carbon metal composite layer 130 on the exposed cut surface may be observed by SEM or TEM, or after the lithium secondary battery 100 is disassembled into each component, the surface of the carbon metal composite layer 130 is etched with a focused ion beam (FIB), an inside of the carbon metal composite layer 130 is exposed, and the exposed surface may be observed by SEM or TEM. Since the fibrous carbon material in the layer after forming the carbon metal composite layer forms a three-dimensional network structure, the SEM or TEM image of the exposed surface includes a fibrous carbon material extending in a direction perpendicular to the image, and/or a fibrous carbon material extending in a direction parallel to the image. Therefore, the average diameter is able to be calculated by extracting a plurality (preferably at least 3 or more as described above) of such fibrous carbon materials from SEM or TEM images.

A fibrous carbon material having an average fiber diameter within the above range is able to be manufactured by a known manufacturing method, and is also able to be acquired by being commercially available. When a fibrous carbon material is acquired by being commercially available, it is possible to acquire the fibrous carbon material having an average fiber diameter within the above range by referring to the manufacturer's public information. After acquisition, the average fiber diameter is preferably measured by the method described above.

A length of the fibrous carbon material is not particularly limited, but from a standpoint that the three-dimensional network structure of the fibrous carbon material is more easily formed, is preferably defined by a ratio of the fiber length to a fiber diameter of the fibrous carbon material (hereinafter, also referred to as “aspect ratio”). From the same standpoint, the average aspect ratio of the fibrous carbon material is preferably 20 or more and 5,000 or less, more preferably 100 or more and 4,000 or less, further more preferably 300 or more and 3,000 or less, and particularly preferably 400 or more and 2,500 or less.

The length of the fibrous carbon material is able to be measured by a known measurement method, for example, is able to be measured by a scanning electron microscope (SEM) or a transmission electron microscope (TEM). More specifically, the same method as for measuring the fiber diameter of the fibrous carbon material may be used (in a case of observing the fibrous carbon material after forming the carbon metal composite layer, the fibrous carbon material in the layer forms a three-dimensional network structure, and thus the SEM or TEM image of the exposed surface includes a fibrous carbon material extending in a direction parallel to the image. Therefore, the average length is able to be calculated by extracting a plurality of such fibrous carbon materials from the SEM or TEM image). The average ratio (aspect ratio) of the fiber length to the fiber diameter of the fibrous carbon material may be obtained by measuring the fiber diameter and the fiber length for each fibrous carbon material by the method described above, then calculating the ratio to obtain an aspect ratio, and calculating an arithmetic mean of the calculated aspect ratios. Alternatively, the average aspect ratio of the fibrous carbon material may be obtained by calculating the average fiber diameter and the average fiber length of the fibrous carbon material by the above method, and then calculating the ratio of the values (average fiber length/average fiber diameter).

A fibrous carbon material having an aspect ratio within the above range is able to be manufactured by a known manufacturing method and is able to be acquired by being commercially available. When the fibrous carbon material is acquired by being commercially available, the fibrous carbon material having an aspect ratio within the above range is able to be acquired by referring to the manufacturer's public information. After acquisition, it is preferable to measure the aspect ratio by the above method.

Preferable specific examples of the fibrous carbon material contained in the carbon metal composite layer 130 include single-wall carbon nanotubes (hereinafter, also referred to as “SWCNT”), multi-wall carbon nanotubes (hereinafter, also referred to as “MWCNT”), and carbon nanofibers (hereinafter, also referred to as “CF”). Among the carbon nanofibers, vapor-grown carbon nanofibers (hereinafter, also referred to as “VGCF”) are preferably used. One or more of the fibrous carbon materials may be used either singly or in combination.

A content of the fibrous carbon material in the carbon metal composite layer 130 is not particularly limited, but the ratio of a volume occupied by the fibrous carbon material in the carbon metal composite layer is preferably in a range of 0.1% or more and 50.0% or less. When the ratio of a volume occupied by the fibrous carbon material is 0.1% or more, the three-dimensional network structure of the fibrous carbon material tends to be formed more easily, and when the ratio of a volume occupied by the fibrous carbon material is 50.0% or less, the affinity of the surface of the carbon metal composite layer with the lithium metal tends to be further improved. From the same standpoint, the ratio of a volume occupied by the fibrous carbon material in the carbon metal composite layer is more preferably 1.0% or more and 40.0% or less, further more preferably 2.0% or more and 35.0% or less, even further more preferably 2.5% or more and 30.0% or less, and particularly preferably 3.0% or more and 20.0% or less.

The ratio of a volume occupied by the fibrous carbon material in the carbon metal composite layer is able to be measured by a known measurement method. For example, the ratio of a volume occupied by the fibrous carbon material is able to be measured by cutting the lithium secondary battery 100 in a thickness direction and observing the carbon metal composite layer 130 in the exposed cut surface by SEM or TEM. Alternatively, the ratio of a volume occupied by the fibrous carbon material is able to be measured by disassembling the lithium secondary battery 100 into each component, etching the surface of the carbon metal composite layer 130 with a focused ion beam (FIB), exposing the inside of the carbon metal composite layer 130, and then observing the exposed surface by SEM or TEM. More specifically, by subjecting the SEM image or TEM image obtained as described above to binary analysis using image analysis software to measure a ratio of an area occupied by the fibrous carbon material on the measurement surface, the obtained ratio of an area occupied by the fibrous carbon material may be regarded as a ratio of a volume occupied by the fibrous carbon material in the carbon metal composite layer. The ratio of a volume occupied by the fibrous carbon material in the carbon metal composite layer is able to be controlled, for example, by using a method of producing a carbon metal composite layer described below.

An amount of the fibrous carbon material applied on the surface of the negative electrode is not particularly limited, but is preferably 0.1 μg or more, more preferably 0.2 μg or more, and further more preferably 0.3 μg or more per 1 cm² of the negative electrode. As the applied amount of the fibrous carbon material is within the above range, the three-dimensional network structure of the fibrous carbon material tends to be formed more easily. In addition, the applied amount of the fibrous carbon material is preferably 10 mg/cm² or less, more preferably 5 mg/cm² or less, further more preferably 1 mg/cm² or less, even further more preferably 100 μg/cm² or less, still further more preferably 50 μg/cm² or less, and particularly preferably 10 μg/cm² or less. As the applied amount of the fibrous carbon material is within the above range, the affinity of the surface of the carbon metal composite layer with a lithium metal tends to be further improved. The applied amount of the fibrous carbon material is able to be measured by a known method in the prior art, for example, a mass of the negative electrode before and after applying the fibrous carbon material is able to be measured, and the difference is able to be obtained.

The carbon metal composite layer 130 includes a metal. As the carbon metal composite layer 130 includes a metal, the surface of the carbon metal composite layer has a more excellent affinity with the lithium metal than a case where the carbon metal composite layer is made of only a fibrous carbon material, and peeling-off of the lithium metal deposited on the surface of the negative electrode is able to be suppressed. In general, in a lithium secondary battery in which charging and discharging are performed by depositing lithium metal on the surface of the negative electrode and electrolytically dissolving the deposited lithium metal, a capacity of the battery decreases by peeling-off of the deposited lithium metal, that is, peeling of the deposited lithium metal decreases cycle characteristics of the lithium secondary battery. Therefore, as the carbon metal composite layer 130 includes a metal, it is possible to suppress peeling-off of the deposited lithium metal on the surface of the negative electrode, and the lithium secondary battery has more excellent cycle characteristics.

From a standpoint of further improving the affinity of the surface of the carbon metal composite layer with lithium metal, the carbon metal composite layer 130 preferably includes at least one metal selected from the group consisting of Sn, Zn, Bi, Ag, In, Pb, and Al. From the same standpoint, the carbon metal composite layer 130 more preferably includes at least one metal selected from the group consisting of Sn, Zn, Ag, Bi, and Al.

A thickness of the carbon metal composite layer 130 is not particularly limited and is preferably 5 nm or more, more preferably 10 nm or more, and further more preferably 15 nm or more. As the thickness of the carbon metal composite layer is within the above range, effects of the aforesaid carbon metal composite layer 130 tend to be exhibited effectively and reliably. In addition, the thickness of the carbon metal composite layer is preferably 5,000 nm or less, more preferably 3,000 nm or less, further more preferably 1,000 nm or less, even further more preferably 500 nm or less, still further more preferably 300 nm or less, and particularly preferably 100 nm or less. As the thickness of the carbon metal composite layer is within the above range, the lithium secondary battery tends to have a higher energy density and more excellent cycle characteristics because the electrical resistance in the lithium secondary battery decreases.

The thickness of the carbon metal composite layer is able to be measured using a known measurement method. For example, the thickness of the carbon metal composite layer is able to be measured by cutting the lithium secondary battery 100 in a thickness direction and observing the carbon metal composite layer 130 in the exposed cut surface by SEM or TEM.

### Positive Electrode

The positive electrode 110 is not particularly limited insofar as it is a positive electrode generally used in a lithium secondary battery, and a known material is able to be appropriately selected, depending on the use of the lithium secondary battery. From a standpoint of increasing stability and an output voltage of the lithium secondary battery, the positive electrode 110 preferably has a positive-electrode active material.

In the present specification, the term “positive-electrode active material” means a material for retaining a lithium ion on the positive electrode 110 and the material may also be rephrased as a host material for the lithium ion.

Examples of such a positive-electrode active material include, but are not particularly limited to, a metal oxide and a metal phosphate. The metal oxide is not particularly limited and examples thereof include a cobalt oxide-based compound, a manganese oxide-based compound, a nickel oxide-based compound, and the like. The metal phosphate is not particularly limited and examples thereof include an iron phosphate-based compound, a cobalt phosphate-based compound, and the like. Examples of a typical positive-electrode active material include LiCoO₂, LiNiₓCo_{y}Mn_{z}O (x+y+z=1), LiNiₓMn_{y}O (x+y=1), LiNiO₂, LiMn₂O₄, LiFePO, LiCoPO, LiFeOF, LiNiOF, and TiS₂. One or more of the positive-electrode active materials may be used either singly or in combination.

The positive electrode 110 may contain components other than the positive-electrode active material. Such a component is not particularly limited and examples thereof include known conductive aids, binders, solid polymer electrolytes, and inorganic solid electrolytes.

The conductive aid in the positive electrode 110 is not particularly limited, and examples thereof include carbon black, single-wall carbon nanotubes (SWCNT), multi-wall carbon nanotubes (MWCNT), carbon nanofibers (CF), acetylene black, and the like. In addition, the binder is not particularly limited and examples thereof include polyvinylidene fluoride, polytetrafluoroethylene, styrene butadiene rubber, acrylic resin, polyimide resin, and the like.

A content of the positive-electrode active material in the positive electrode 110 may be, for example, 50 mass % or more and 100 mass % or less relative to the overall mass of the positive electrode 110. A content of the conductive aid may be, for example, 0.5 mass % or more and 30 mass % or less relative to the overall mass of the positive electrode 110. A content of the binder may be, for example, 0.5 mass % or more and 30 mass % or less relative to the overall mass of the positive electrode 110. A total amount of the solid polymer electrolyte and the inorganic solid electrolyte may be, for example, 0.5 mass % or more and 30 mass % or less relative to the overall mass of the positive electrode 110.

### Positive Electrode Current Collector

A positive electrode current collector may be placed on one side of the positive electrode 110. The positive electrode current collector is not particularly limited insofar as it is a conductor that does not react with a lithium ion in the battery. Examples of such a positive electrode current collector include aluminum.

An average thickness of the positive electrode current collector is preferably 4 μm or more and 20 μm or less, more preferably 5 μm or more and 18 μm or less, and further more preferably 6 μm or more and 15 μm or less. In such a mode, an occupied volume of the positive electrode current collector in the lithium secondary battery 100 decreases, and thus the lithium secondary battery 100 has a more improved energy density.

### Separator

The separator 120 is a member for securing ionic conductivity of lithium ions that serve as a charge carrier between the positive electrode 110 and the negative electrode 140 while preventing short circuit of the battery by separating the positive electrode 110 and the negative electrode 140, and is composed of a material that does not have electronic conductivity and does not react with the lithium ions. In addition, the separator 120 also has a role of retaining electrolyte solution. Although the material itself constituting the separator does not have ionic conductivity, the separator retains the electrolyte solution so that the lithium ions are conducted through the electrolyte solution. The separator 120 is not limited insofar as it is able to play the above role, and may be composed of, for example, a porous polyethylene (PE) film, a polypropylene (PP) film, or a stacked structure thereof.

The separator 120 may be covered with a separator coating layer. The separator coating layer may cover both of the surfaces of the separator 120 or may cover only one surface. The separator coating layer is not particularly limited insofar as it is a member that has ionic conductivity and does not react with a lithium ion, and is preferably capable of firmly adhering the separator 120 to a layer adjacent to the separator 120. Such a separator coating layer is not particularly limited and examples thereof include members containing a binder such as polyvinylidene fluoride (PVDF), a composite material (SBR-CMC) of styrene butadiene rubber and carboxymethyl cellulose, polyacrylic acid (PAA), lithium polyacrylate (Li-PAA), polyimide (PI), polyamideimide (PAI), and aramid. The separator coating layer may be obtained by adding, to the binder, inorganic particles such as silica, alumina, titania, zirconia, magnesium oxide, magnesium hydroxide, or lithium nitrate. The separator 120 may be a separator having no separator coating layer, or a separator having the separator coating layer.

An average thickness of the separator 120 is preferably 20 μm or less, more preferably 18 μm or less, and further more preferably 15 μm or less. In such a mode, the occupied volume of the separator 120 in the lithium secondary battery 100 decreases and therefore, the lithium secondary battery 100 has a more improved energy density. In addition, the average thickness of the separator 120 is preferably 5 μm or more, more preferably 7 μm or more, and further more preferably 10 μm or more. In such a mode, the positive electrode 110 is able to be separated from the negative electrode 140 more reliably and a short circuit of the battery is able to be further suppressed.

### Conductive Thin Film

A conductive thin film is formed on a surface of the separator 120 facing the negative electrode 140. That is, the conductive thin film is arranged at an interface between the separator 120 and the carbon metal composite layer 130. By providing such a thin film having conductivity on the surface of the separator, the electric potential of the surface of the separator is able to be made uniform while maintaining the ionic conductivity of the separator 120 sufficiently high, and uniform lithium metal is able to be deposited on the negative electrode synergistically with the carbon metal composite layer.

The conductive thin film is not particularly limited insofar as it is a thin film having conductivity, but is preferably a thin film consisting of a metal or an alloy, a thin film consisting of carbon, or a stacked film of the thin films. In a case where the above material is used for the conductive thin film, irreversible incorporation of lithium ions into the conductive thin film is suppressed, and the cycle characteristics of the battery tend to be further improved.

A metal that forms the conductive thin film, or a metal element that the alloy includes is not particularly limited. In a case of using an element that forms an alloy with lithium, it is preferable that a metal or alloy that does not form an alloy with lithium, or a thin film consisting of the above carbon thin film is arranged as a base film on the separator side, and then a thin film is formed with a metal or an alloy that forms an alloy with lithium thereon. Examples of metals and alloys that do not form alloys with lithium include Cu, Ni, Fe, Mn, Ti, Cr, stainless steel, and the like. Examples of metals and alloys that form alloys with lithium include Si, Sn, Al, In, Zn, Ag, Bi, Pb, Sb, alloys containing these elements, and the like.

A thin film made of carbon is preferably made of spa carbon, and examples of such a thin film include a diamond-like carbon (DLC) thin film. A thin film consisting of carbon may be stacked on a thin film consisting of a metal or an alloy on a separator, or may be patterned in-plane.

A film thickness of the conductive thin film is preferably 1 μm or less. As the film thickness of the conductive thin film is 1 μm or less, the ionic conductivity of the separator 120 is able to be maintained at a higher level. The film thickness of the conductive thin film is preferably set to, for example, 0.9 μm, 0.8 μm, 0.7 μm, 0.6 μm, 0.5 μm, 0.4 μm, 0.3 μm, 0.2 μm, 0.1 μm (100 nm), 90 nm, 80 nm, 70 nm, 60 nm, 50 nm, 40 nm, 30 nm, 20 nm, 10 nm, 8 nm, 5 nm, or values therebetween. Examples of a preferable range of the film thickness are, for example, 5 nm or more and 200 nm or less, or 8 nm or more and 100 nm or less. In a case where the conductive thin film has a stacked structure of a plurality of layers, the total thickness is preferably within the above range. A thickness of the conductive thin film is able to be measured using a known measurement method. For example, the thickness of the conductive thin film is able to be measured by cutting the lithium secondary battery 100 or the separator on which the conductive thin film is formed in the thickness direction, and observing the conductive thin film on the exposed cut surface by SEM or TEM.

In addition, there is also a method of forming a coating film consisting of carbonaceous particles and a binder component on the separator in order to give conductivity to the separator surface, but such a method is not preferable from standpoints that the binder component acts to hinder conductivity, that lithium ions are irreversibly incorporated into such a coating film, that it is difficult to uniformly form a coating film with a thickness of 1 μm or less on the surface of the separator, and the like. In the present embodiment, even in a case where a thin film consisting of carbon is used as the conductive thin film, the thin film is clearly distinguished from the coating film consisting of the carbonaceous particles and the binder component in that the thin film does not contain the binder component as described above and consists only of carbon. A thin film made of carbon is able to realize a low resistance and a uniform film thickness while making the film thickness thinner than a coating film (carbon coating layer) in which carbonaceous particles are dispersed in a binder component.

### Electrolyte Solution

It is preferable that the lithium secondary battery 100 further includes an electrolyte solution. The separator 120 may be wetted with the electrolyte solution or the lithium secondary battery 100 may be sealed with the electrolyte solution to obtain a finished product. The electrolyte solution is a solution that contains an electrolyte and a solvent and has ionic conductivity, and acts as a conductive path of a lithium ion. Therefore, the lithium secondary battery 100 having the electrolyte solution has a more reduced internal resistance and a more improved energy density, capacity, and cycle characteristics.

The electrolyte is not particularly limited insofar as it is a salt, and examples thereof include salts of Li, Na, K, Ca, or Mg. Among these, as the electrolyte, a lithium salt is preferably used. The lithium salt is not particularly limited, and examples thereof include LiI, LiCl, LiBr, LiF, LiBF₄, LiPF₆, LiAsF₆, LiSO₃CF₃, LiN(SO₂F)₂, LiN(SO₂CF₃)₂, LiN(SO₂CF₃CF₃)₂, LiB(O₂C₂H₄)₂, LiB(O₂C₂H₄)F₂, LiB(OCOCF₃)₄, LiNO₃, and Li₂SO₄. The lithium salt is preferably LiN(SO₂F)₂ from a standpoint of more excellent energy density, capacity, and cycle characteristics of the lithium secondary battery 100. One or more of the lithium salts may be used either singly or in combination.

The solvent is not particularly limited and examples thereof include dimethoxy ethane, dimethyl ether, diethylene glycol dimethyl ether, triethylene glycol dimethyl ether, acetonitrile, dimethyl carbonate, diethyl carbonate, ethyl methyl carbonate, ethylene carbonate, propylene carbonate, chloroethylene carbonate, fluoroethylene carbonate, difluoroethylene carbonate, trifluoromethyl propylene carbonate, methyl acetate, ethyl acetate, propyl acetate, methyl propionate, ethyl propionate, nonafluorobutyl methyl ether, nonafluorobutyl ethyl ether, tetrafluoroethyl tetrafluoropropyl ether, trimethyl phosphate, triethyl phosphate, and the like. One or more of these solvents may be used either singly or in combination.

### Use of Lithium Secondary Battery

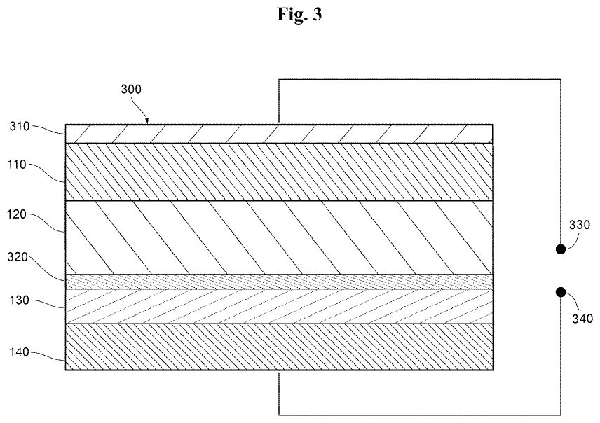

FIG. 3 illustrates a mode of the use of the lithium secondary battery of the present embodiment. A lithium secondary battery 300 is obtained by placing a positive electrode current collector 310 on a surface opposite to a surface of the positive electrode 110 facing the separator 120, for the lithium secondary battery 100.

In the lithium secondary battery 300, a positive electrode terminal 330 and a negative electrode terminal 340 for connecting the lithium secondary battery 300 to an external circuit are bonded to a positive electrode current collector 310 and a negative electrode 140, respectively. The lithium secondary battery 300 is charged/discharged by connecting the negative electrode terminal 340 to one end of the external circuit and the positive electrode terminal 330 to the other end of the external circuit.

In the lithium secondary battery 300, a solid electrolyte interfacial layer (SEI layer) 320 may be formed at the interfacial between the carbon metal composite layer 130 and the conductive thin film formed on the separator 120 by initial charge. The SEI layer 320 to be formed is not particularly limited and may contain, for example, a lithium-containing inorganic compound, a lithium-containing organic compound, and the like. A typical average thickness of the SEI layer is 1 nm or more and 10 μm or less.

The lithium secondary battery 300 is charged by applying a voltage between the positive electrode terminal 330 and the negative electrode terminal 340 to cause a current flow from the negative electrode terminal 340 to the positive electrode terminal 330 through the external circuit. By charging the lithium secondary battery 300, deposition of lithium metal occurs on the surface of the negative electrode. The deposition of the lithium metal occurs on at least one location of the interface between the negative electrode 140 and the carbon metal composite layer 130, the interface between the carbon metal composite layer 130 and the SEI layer 320, and the interface between the SEI layer 320 and the separator 120.

When the positive electrode terminal 330 and the negative electrode terminal 340 are connected to the charged lithium secondary battery 300, the lithium secondary battery 300 is discharged. With this, the deposition of the lithium metal occurred on the surface of the negative electrode is electrolytically dissolved.

In the lithium secondary battery 300 of the present embodiment, the SEI layer 320 may not be formed, and may be formed at the interface between the negative electrode 140 and the carbon metal composite layer 130.

### Method of Manufacturing Lithium Secondary Battery

A method of manufacturing the lithium secondary battery 100 illustrated in FIG. 1 is not particularly limited insofar as it is a method capable of manufacturing a lithium secondary battery including the aforesaid structure, and examples thereof include the method described below.

First, the positive electrode 110 is prepared by a known manufacturing method or by purchasing a commercially available one. The positive electrode 110 is manufactured in the following manner, for example. The positive-electrode active material described above, a known conductive aid, and a known binder are mixed together to obtain a positive electrode mixture. For a mixing ratio thereof, for example, the positive-electrode active material may be 50 mass % or more and 99 mass % or less, the conductive aid may be 0.5 mass % or more and 30 mass % or less, the binder may be 0.5 mass % or more and 30 mass % or less based on a total amount of the positive electrode mixture. The obtained positive electrode mixture is applied to one side of a metal foil (for example, Al foil) having a thickness of, for example, 5 μm or more and 1 mm or less, and press-molded. The obtained molded product is punched into a predetermined size to obtain a positive electrode 110.

Next, a separator 120 having the aforesaid structure is prepared. As the separator 120, a separator manufactured by a known method in the prior art or a commercially available one may be used.

Next, a conductive thin film is formed on one or both sides of the separator, preferably on one side. A method of forming a conductive thin film is not particularly limited, but CVD method, PVD method, vacuum deposition, sputtering, electroless plating, electrolytic plating, and the like may be used. The method of forming a conductive thin film is preferably sputtering.

Next, the aforesaid negative electrode material, for example, a metal foil (for example, electrolytic Cu foil) having a thickness of 1 μm or more and 1 mm or less is washed with a sulfamic-acid-containing solvent, punched into a predetermined size, ultrasonically washed with ethanol, and then dried to obtain a negative electrode 140.

Next, the carbon metal composite layer 130 is formed on one side of the negative electrode 140. Examples of the method of forming the carbon metal composite layer include an electroless plating, an electrolytic plating, a powder metallurgy method, a vapor deposition method, and the like.

Examples of the electroless plating include a method of using a plating solution containing a metal ion, a fibrous carbon material, and a reducing agent. Specific examples include a method of immersing the negative electrode 140 in a plating solution, a method of applying a plating solution to the negative electrode 140 by spin coating, and the like. In the electroless plating, by adjusting a concentration of the fibrous carbon material in the plating solution, it is possible to control a ratio of a volume occupied by the fibrous carbon material in the carbon metal composite layer.

Examples of the electrolytic plating include a method of performing electrolytic plating with the negative electrode 140 as a work electrode in an electrolytic plating solution containing a metal ion and/or a fibrous carbon material. The electrolysis conditions and time is able to be appropriately adjusted depending on the metal ions and the negative electrode 140 to be used. In the electrolytic plating, by performing electrolytic plating in an electrolytic plating solution containing a metal ion and a fibrous carbon material, a carbon metal composite layer may be formed at once. Alternatively, by immersing the negative electrode in a solution containing a fibrous carbon material, depositing the charged fibrous carbon material on the surface of the negative electrode using an electrophoresis method, and then performing electrolytic plating in another solution (plating solution) containing metal ions, a carbon metal composite layer may be formed. In addition, in the electrolytic plating, by adjusting a concentration of a fibrous carbon material in a plating solution, it is possible to control a ratio of a volume occupied by the fibrous carbon material in the carbon metal composite layer.

Examples of the powder metallurgy method include a method in which metal powders and fibrous carbon material powders are mixed, press-molded, and then calcinated. In addition, in the powder metallurgy method, the ratio of a volume occupied by the fibrous carbon material in the carbon metal composite layer is able to be controlled by adjusting a mixing ratio of the materials.

Examples of the vapor deposition method include a method of obtaining a carbon metal composite layer by applying a fibrous carbon material on the negative electrode 140 and then depositing a metal on the negative electrode. In addition, in the vapor deposition method, by adjusting the applied amount of the fibrous carbon material, it is possible to control a ratio of a volume occupied by the fibrous carbon material in the carbon metal composite layer.

In any of the electroless plating, the electrolytic plating, the powder metallurgy method, and the vapor deposition method, by calcinating the carbon metal composite layer formed on the surface of the negative electrode after forming the carbon metal composite layer, a denser carbon metal composite layer may be obtained. In addition, two or more methods of the electroless plating, the electrolytic plating, the powder metallurgy method, and the vapor deposition method may be combined. For example, by immersing the negative electrode in a solution containing a fibrous carbon material, depositing the charged fibrous carbon material on the surface of the negative electrode using an electrophoresis method, and then immersing the negative electrode in a plating solution containing metal ions to deposit the metal by electroless plating, a carbon metal composite layer may be obtained. From a standpoint of high productivity and a standpoint of easily forming a three-dimensional network structure of a fibrous carbon material, a carbon metal composite layer is preferably formed by the method described in examples. In particular, performing metal plating while depositing the fibrous carbon material on the surface of the negative electrode is preferable from a standpoint of precisely controlling a applied amount of the fibrous carbon material.

The positive electrode 110, the separator 120, and the negative electrode 140 having the carbon metal composite layer 130 thereon, each obtained as described above, are stacked in this order so that the carbon metal composite layer 130 faces a surface of the separator 120 on which a conductive thin film is formed and thus, a stacked body is obtained. The stacked body thus obtained is encapsulated, together with the electrolyte solution in a hermetically sealing container to obtain a lithium secondary battery 100. The hermetically sealing container is not particularly limited and examples thereof include a laminate film.

### Second Embodiment

### Lithium Secondary Battery

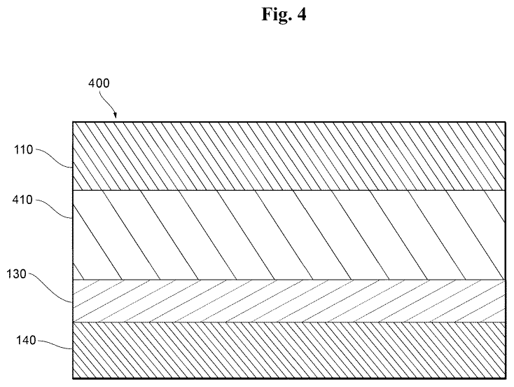

FIG. 4 is a schematic cross-sectional view of a lithium secondary battery of Second Embodiment. As illustrated in FIG. 4, the lithium secondary battery 400 in Second Embodiment includes a positive electrode 110, a negative electrode 140 not having a negative-electrode active material, a solid electrolyte 410 placed between the positive electrode 110 and the negative electrode 140, and a carbon metal composite layer 130 formed on a surface of the negative electrode 140 facing the solid electrolyte 410. A conductive thin film (not illustrated in FIG. 3) is formed on the surface of the solid electrolyte 410 facing the negative electrode 140.

The structure and preferable modes of the positive electrode 110, the carbon metal composite layer 130, the negative electrode 140, and the conductive thin film are the same as those of the lithium secondary battery 100 in First Embodiment, and the lithium secondary battery 400 exhibits the same effects as the lithium secondary battery 100.

### Solid Electrolyte

In general, a battery having a liquid electrolyte tends to be exposed to different physical pressures, which are applied from the electrolyte to the surface of a negative electrode, at different locations due to the shaking of the liquid. On the other hand, since the lithium secondary battery 400 has the solid electrolyte 410, a pressure applied from the solid electrolyte 410 to the surface of the negative electrode 140 becomes more uniform and a shape of lithium metal deposited on the surface of the negative electrode 140 is able to be made more uniform. That is, since the lithium metal deposited on the surface of the negative electrode 140 in such a mode is suppressed from growing into dendrite form, the cycle characteristics of the lithium secondary battery 400 are further improved.

The solid electrolyte 410 is not particularly limited insofar as it is used generally for a lithium solid secondary battery and a known material is able to be appropriately selected, depending on the use of the lithium secondary battery 400. The solid electrolyte 410 preferably has ionic conductivity and no electronic conductivity. Since the solid electrolyte 410 has ionic conductivity and no electronic conductivity, the lithium secondary battery 400 has more reduced internal resistance and in addition, the lithium secondary battery 400 is suppressed from causing a short circuit inside thereof. As a result, the lithium secondary battery 400 has a more excellent energy density, capacity, and cycle characteristics.

The solid electrolyte 410 is not particularly limited and examples thereof include those containing a resin and a lithium salt. The resin is not particularly limited and examples thereof include a resin having an ethylene oxide unit in a main chain and/or a side chain, an acrylic resin, a vinyl resin, an ester resin, a nylon resin, polysiloxane, polyphosphazene, polyvinylidene fluoride, polymethyl methacrylate, polyamide, polyimide, aramid, polylactic acid, polyethylene, polystyrene, polyurethane, polypropylene, polybutylene, polyacetal, polysulfone, and polytetrafluoroethylene. One or more of the resins may be used either singly or in combination.

Examples of the lithium salt contained in the solid electrolyte 410 are not particularly limited and examples thereof include LiI, LiCl, LiBr, LiF, LiBF₄, LiPF₆, LiAsF₆, LiSO₃CF₃, LiN(SO₂F)₂, LiN(SO₂CF₃)₂, LiN(SO₂CF₃CF₃)₂, LiB(O₂C₂H₄)₂, LiB(O₂C₂H₄)F₂, LiB(OCOCF₃)₄, LiNO₃, Li₂SO₄, and the like. One or more of the aforesaid lithium salts may be used either singly or in combination.

In general, a content ratio of the resin to the lithium salt in the solid electrolyte is determined by the ratio ([Li/]/[O]) of oxygen atoms in the resin to lithium atoms in the lithium salt. In the solid electrolyte 410, a content ratio of the resin to the lithium salt, that is, the ratio ([Li]/[O]) is adjusted to be preferably 0.02 or more and 0.20 or less, more preferably 0.03 or more and 0.15 or less, and further more preferably 0.04 or more and 0.12 or less.

The solid electrolyte 410 may contain a component other than the aforesaid resin and lithium salt. Such a component is not particularly limited and examples thereof include solvents and salts other than the lithium salt. Salts other than the lithium salt are not particularly limited and examples thereof include salts of Li, Na, K, Ca, and Mg.

The solvent is not particularly limited and examples thereof include those exemplified as the solvent of the electrolyte solution which is able to be contained in the lithium secondary battery 100.

An average thickness of the solid electrolyte 410 is preferably 20 μm or less, more preferably 18 μm or less, and further more preferably 15 μm or less. In such a mode, an occupied volume of the solid electrolyte 410 in the lithium secondary battery 400 decreases so that the lithium secondary battery 400 has a more improved energy density. In addition, the average thickness of the solid electrolyte 410 is preferably 5 μm or more, more preferably 7 μm or more, and further more preferably 10 μm or more. In such a mode, the positive electrode 110 is able to be separated from the negative electrode 140 more reliably and a short circuit of the battery is able to be further suppressed.

In the present specification, the term “solid electrolyte” includes a gel electrolyte. The gel electrolyte is not particularly limited and examples thereof include those containing a polymer, an organic solvent, and a lithium salt. The polymer in the gel electrolyte is not particularly limited and examples thereof include copolymers of polyethylene and/or polyethylene oxide, polyvinylidene fluoride, copolymers of polyvinylidene fluoride and hexafluoropropylene, and the like.

In FIG. 3, a solid electrolyte interfacial layer (SEI layer) may be formed on the surface of the negative electrode 140 and/or the carbon metal composite layer 130. The SEI layer to be formed is not particularly limited and it may contain a lithium-containing inorganic compound, a lithium-containing organic compound, or the like. A typical average thickness of the SEI layer is 1 nm or more and 10 μm or less.

### Method of Manufacturing Secondary Battery

The lithium secondary battery 400 is able to be manufactured in the same manner as the method of manufacturing the lithium secondary battery 100 according to the aforesaid First Embodiment, except that the solid electrolyte is used instead of the separator.

The method of manufacturing a solid electrolyte 410 is not particularly limited insofar as it is a method of obtaining the aforesaid solid electrolyte 410, and may be performed, for example, as follows. A resin used in the prior art in a solid electrolyte and a lithium salt (for example, the aforesaid resin and lithium salt as resins that the solid electrolyte 410 may contain) are dissolved in an organic solvent. The obtained solution is cast on a molding substrate to have a predetermined thickness and thus, the solid electrolyte 410 is obtained. Here, the mixing ratio of the resin and the lithium salt may be determined based on a ratio ([Li]/[O]) of oxygen atoms of the resin to lithium atoms of the lithium salt. The ratio ([Li]/[O]) is, for example, 0.02 or more and 0.20 or less. In addition, although the organic solvent is not particularly limited, for example, acetonitrile may be used. A molding substrate is not particularly limited and, for example, a PET film or a glass substrate may be used.

As a method of forming a conductive thin film on a solid electrolyte, the same method as the method of forming the conductive thin film on the separator is able to be used.

### Modification Example

The embodiments are examples for describing the present invention, the gist of the present invention does not restrict the present invention only to the present embodiment, and the present invention is able to have various modifications without departing from the gist thereof.

For example, in the lithium secondary battery 100 of First Embodiment and the lithium secondary battery 400 of Second Embodiment, the carbon metal composite layer 130 may be formed on both sides of the negative electrode 140. In this case, in the lithium secondary battery, each structure is stacked in the following order: positive electrode/separator or solid electrolyte/carbon metal composite layer/negative electrode/carbon metal composite layer/separator or solid electrolyte/positive electrode. In such a mode, a capacity of the lithium secondary battery is able to be improved.

The lithium secondary battery of the present embodiment may be a lithium solid secondary battery. In such a mode, since an electrolyte solution is not required to be used, a problem of electrolyte solution leakage is not generated and the safety of the battery is further improved.

The lithium secondary battery of the present embodiment may have a current collector which is to be placed on the surface of the negative electrode and/or positive electrode so as to be in contact with the negative electrode or positive electrode. Such a current collector is not particularly limited and examples thereof include those usable as a negative electrode material. In a case where the lithium secondary battery has neither a positive electrode current collector nor a negative electrode current collector, the positive electrode and the negative electrode themselves serve as current collectors, respectively.

In the lithium secondary battery of the present embodiment, a terminal for connecting to an external circuit may be attached to a positive electrode or a positive electrode current collector and/or a negative electrode. For example, a metal terminal (for example, Al, Ni, and the like) having a length of 10 μm or more and 1 mm or less may be bonded to one or both of the positive electrode current collector and the negative electrode. As a bonding method, a known method in the prior art may be used, for example, ultrasonic welding may be used.

In the present specification, “the energy density is high” or “high energy density” means that the capacity is high per the total volume or total mass of the battery, and is preferably 800 Wh/L or more or 350 Wh/kg or more, more preferably 900 Wh/L or more or 400 Wh/kg or more, and further more preferably 1,000 Wh/L or more or 450 Wh/kg or more.

In addition, in the present specification, “excellent cycle characteristics” means that a reduction rate of the capacity of the battery is low before and after the number of charging/discharging cycles that is able to be assumed in normal use. That is, it means that when comparing an initial capacity and a capacity after the number of charging/discharging cycles that is able to be assumed in normal use, the capacity after charging/discharging cycles is hardly decreased relative to the initial capacity. Here, the “number assumed in normal use” varies depending on the use of the lithium secondary battery, and is, for example, 30 times, 50 times, 100 times, 300 times, 500 times, or 1,000 times. In addition, the term “capacity after charging/discharging cycles is hardly decreased compared with the initial capacity” means, though varying depending on the use of the lithium secondary battery, and that, for example, the capacity after charging/discharging cycles is 65% or more, 70% or more, 75% or more, 80% or more, 85% or more, or 90% or more relative to the initial capacity.

### EXAMPLES

Hereinafter, the present invention will be specifically described using examples and comparative examples. The present invention is not limited by the following examples.

### Measurement of Various Physical Properties of Fibrous Carbon Material

An average fiber diameter and an aspect ratio of the fibrous carbon material, and a ratio of a volume occupied by the fibrous carbon material in the carbon metal composite layer were measured using FIB and SEM. Specifically, the surface of the carbon metal composite layer formed on the negative electrode was etched by FIB using a gallium ion beam under a condition of an acceleration voltage of 30 kV to expose an inside of the carbon metal composite layer. After that, by observing the fibrous carbon material extending in the surface direction in the surface exposed by the etching using SEM, the fiber diameter and aspect ratio of the fibrous carbon material, and the ratio of a volume occupied by the fibrous carbon material in the carbon metal composite layer were measured. Image analysis software attached to the SEM was used to calculate each value.

Each value of the average fiber diameter and the average aspect ratio of the fibrous carbon material, and the ratio of a volume occupied by the fibrous carbon material in the carbon metal composite layer was obtained by calculating the arithmetic mean of the results of five times of measurements. Since the measurement is a destructive measurement, a different sample was used which was produced under the same production condition as the sample used for obtaining characteristics of the battery, which will be described later, as the sample. In addition, after the masses of the negative electrode before and after the fibrous carbon material was applied were measured, the applied amount (μg/cm²) of the fibrous carbon material was obtained from the difference therebetween.

### Example 1

A lithium secondary battery was produced as follows.

First, a 10 μm of electrolytic Cu foil was washed with a sulfamic-acid-containing solvent, punched into a predetermined size (45 mm×45 mm), ultrasonically washed with ethanol, and then dried to obtain a negative electrode.

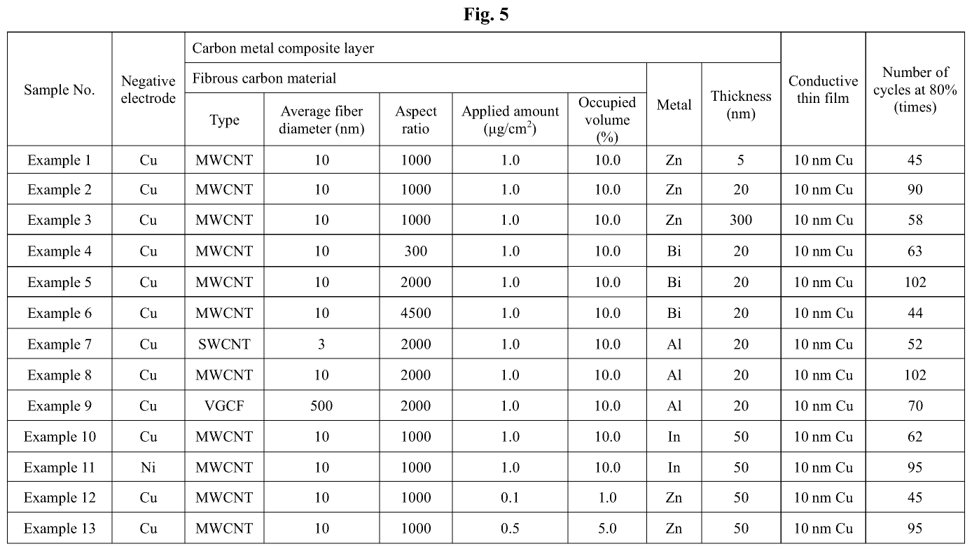

After degreasing the obtained negative electrode and washing thereof with pure water, the negative electrode was immersed in a liquid bath in which the fibrous carbon material was dispersed, and the fibrous carbon material charged by using an electrophoresis method was deposited on the surface of the negative electrode. After the negative electrode on which the carbon material was deposited was removed from the liquid bath, the negative electrode was immersed in another plating bath containing zinc. By performing electrolytic plating on the surface of the negative electrode with the negative electrode left still horizontally, the surface of the negative electrode on which the fibrous carbon material was deposited was plated with zinc to form a carbon metal composite layer on the surface of the negative electrode. The negative electrode on which the carbon metal composite layer was formed was removed from the plating bath, washed with ethanol, and washed with pure water. In such a manner, a carbon metal composite layer was formed on one side of the negative electrode. The table of FIG. 5 shows results of measuring each physical property value of the fibrous carbon material in the carbon metal composite layer. A commercially available fibrous carbon material was used.

Next, a positive electrode was produced. A mixture of 96 parts by mass of LiNi_{0.85}Co_{0.12}Al_{0.03}O₂ as a positive-electrode active material, 2 parts by mass of carbon black as a conductive aid, and 2 parts by mass of polyvinylidene fluoride (PVDF) as a binder was applied to one side of 12 μm-thick Al foil as a positive electrode current collector, and press-molded. The obtained molded product was punched to a predetermined size (40 mm×40 mm) to obtain a positive electrode.

As a separator, a separator having a predetermined size (50 mm×50 mm), in which both surfaces of a 12 μm of polyethylene microporous film were coated with a 2 μm-thick polyvinylidene fluoride (PVDF), was prepared. A copper (Cu) thin film was formed as a conductive thin film on one side of the separator by sputtering. The sputtering time was adjusted so that the thickness of the thin film was 10 nm. The thickness of the conductive thin film was measured by cutting the separator with the thin film formed thereon in the thickness direction and observing the exposed cut surface with an SEM.

As an electrolyte solution, 4M dimethoxyethane (DME) solution of LiN(SO₂F)₂(LFSI) was prepared.

The positive electrode, the separator, and the negative electrode on which the carbon metal composite layer is formed on one side, each obtained as described above, were stacked in this order so that the carbon metal composite layer faces a surface of the separator on which a conductive thin film is formed and thus, a stacked body was obtained. In addition, a 100-μm Al terminal and 100-μm Ni terminal were bonded to the positive electrode and the negative electrode, respectively by ultrasonic welding and then the bonded body was inserted into a laminate exterior body. Next, the electrolyte solution obtained as described above was injected into the exterior body. The exterior body was hermetically sealed to obtain a lithium secondary battery.

### Examples 2 to 24

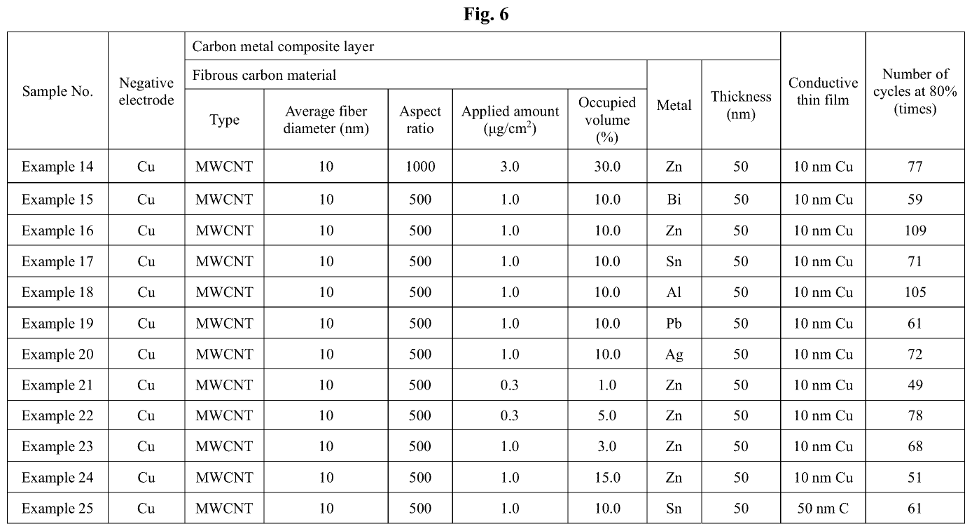

A lithium secondary battery was obtained in the same manner as in Example 1, except that a carbon metal composite layer containing a fibrous carbon material and a metal shown in the tables of FIGS. 5 and 6 was formed using the negative electrode made of the materials shown in the tables of FIGS. 5 and 6. Plating conditions in electrolytic plating were appropriately adjusted according to the type of metal.

### Example 25

A lithium secondary battery was obtained in the same manner as in Example 17, except that a 50 nm-thick carbon (C) thin film was formed as the conductive thin film, instead of the 10 nm-thick Cu thin film. In the table of FIG. 6 shows the results of measuring each physical property value of the fibrous carbon material in the carbon metal composite layer.

### Comparative Example 1

A lithium secondary battery was obtained in the same manner as in Example 1, except that a carbon metal composite layer and a conductive thin film were not formed.

### Comparative Examples 2 and 3

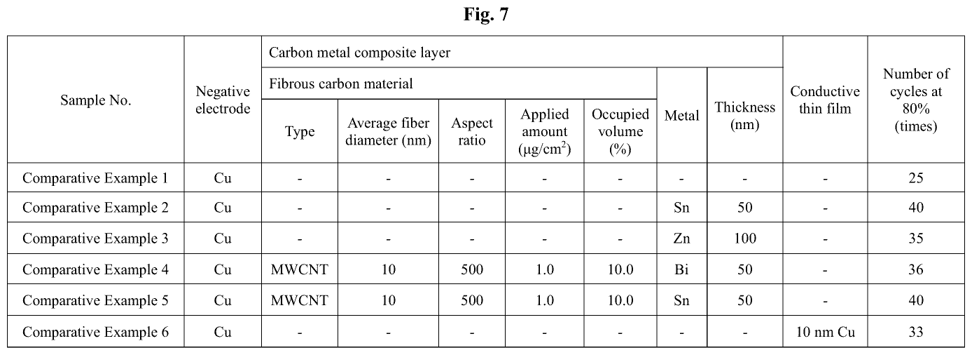

A lithium secondary battery was obtained in the same manner as in Example 1, except that a metal layer composed of the metals shown in the table of FIG. 7 was formed on the negative electrode instead of the carbon metal composite layer, and the conductive thin film was not formed. The method of forming a metal layer was the same as the method of forming a carbon metal composite layer of Example 1, except that a fibrous carbon material was not used. In addition, in the table of FIG. 7, the thicknesses described in Comparative Examples 2 and 3 mean the thicknesses of the metal layers.

### Comparative Examples 4 and 5

In Comparative Example 4, a lithium secondary battery was obtained in the same manner as in Example 15, except that a conductive thin film was not formed. In Comparative Example 5, a lithium secondary battery was obtained in the same manner as in Example 17, except that a conductive thin film was not formed.

### Comparative Example 6

A lithium secondary battery was obtained in the same manner as in Example 1, except that a carbon metal composite layer was not formed.

### Evaluation of Energy Density and Cycle Characteristics

The energy density and cycle characteristics of solid batteries produced in each example and comparative example were evaluated as follows.

The produced lithium secondary battery was charged at 7 mA until the voltage reached 4.2 V, and then discharged at 7 mA until the voltage reached 3.0 V (hereinafter, referred to as “initial discharge”). Next, a cycle of charging at 35 mA until the voltage reached 4.2 V and then discharging at 35 mA until the voltage reached 3.0 V was repeated in an environment of a temperature of 25° C. For all the examples and comparative examples, the capacity obtained from the initial discharge (hereinafter, referred to as “initial capacity”) was 100 mAh, and a capacity area density was 4.0 mAh/cm². For each example, the number of cycles (referred to as “number of cycles at 80%” in the table) when the discharge capacity reached 80% of the initial capacity (that is, 80 mAh) is illustrated in the table of FIG. 5.

In the tables of FIGS. 5 to 7, SWCNT, MWCNT, and VGCF refer to single-wall carbon nanotubes, multi-wall carbon nanotubes, and vapor-grown carbon nanofibers, respectively.

From the tables of FIGS. 5 to 7, it is recognized that Examples 1 to 25 including the carbon metal composite layer and the conductive thin film have larger number of cycles required for reducing the capacity to 80% from the initial capacity, and Examples 1 to 25 including the carbon metal composite layer and the conductive thin film are more excellent in cycle characteristics, compared with Comparative Examples 1 to 6 not having any of the structures.

In the tables of FIGS. 5 and 6, when comparing Examples 1 to 3, 4 to 6, 7 to 9, 10 and 11, and 12 to 14, respectively, effects of the thickness of the carbon metal composite layer, the aspect ratio of the fibrous carbon material, the type of the fibrous carbon material, the material of the negative electrode, and the applied amount of the fibrous carbon material are recognized, respectively. When each example is compared, it is able to be said that the example with the largest number of cycles of 80% has excellent cycle characteristics. In addition, in the tables of FIG. 6, when comparing Examples 15 to 20 and Examples 21 to 24, respectively, effects of the type of the metal contained in the carbon metal composite layer and the occupied volume of the fibrous carbon material are recognized, respectively.

### INDUSTRIAL APPLICABILITY

The lithium secondary battery of the present invention has high energy density and excellent cycle characteristics, and thus has industrial applicability as a power storage device used for various uses.
100, 300, 400 . . . lithium secondary battery
110 . . . positive electrode
120 . . . separator
130 . . . carbon metal composite layer
140 . . . negative electrode
210 . . . lithium metal
220 . . . fibrous carbon materials
310 . . . positive electrode current collector
320 . . . solid electrolyte interfacial layer
330 . . . positive electrode terminal
340 . . . negative electrode terminal
410 . . . solid electrolyte

What is claimed is:

1. A lithium secondary battery comprising:
a positive electrode;
a negative electrode not having a negative-electrode active material;
a separator placed between the positive electrode and the negative electrode;
a carbon metal composite layer formed on a surface of the negative electrode facing the separator; and
a conductive thin film formed on a surface of the separator facing the negative electrode,
wherein the carbon metal composite layer comprises a plurality of fibrous carbon materials, each of which are randomly oriented.

2. A lithium secondary battery comprising:
a positive electrode;
a negative electrode not having a negative-electrode active material;
a solid electrolyte placed between the positive electrode and the negative electrode;
a conductive thin film formed on a surface of the solid electrolyte facing the negative electrode; and
a carbon metal composite layer formed on a surface of the negative electrode facing the solid electrolyte,
wherein the carbon metal composite layer comprises a plurality of fibrous carbon materials, each of which are randomly oriented.

3. The lithium secondary battery according to claim 1, wherein an average fiber diameter of the fibrous carbon material is 2 nm or more and 500 nm or less.

4. The lithium secondary battery according to claim 1, wherein an average ratio of a fiber length to a fiber diameter of the fibrous carbon material is 20 or more and 5,000 or less.

5. The lithium secondary battery according to claim 1, wherein the fibrous carbon material is at least one selected from the group consisting of single-wall carbon nanotubes, multi-wall carbon nanotubes, and carbon nanofibers.

6. The lithium secondary battery according to claim 1, wherein a ratio of a volume occupied by the fibrous carbon material in the carbon metal composite layer is 0.1% or more and 50.0% or less.

7. The lithium secondary battery according to claim 1, wherein a thickness of the carbon metal composite layer is 5 nm or more and 5,000 nm or less.

8. The lithium secondary battery according to claim 1, wherein the carbon metal composite layer comprises at least one metal selected from the group consisting of Sn, Zn, Bi, Ag, In, Pb, and Al.

9. The lithium secondary battery according to claim 1, wherein the lithium secondary battery is a lithium secondary battery in which charging and discharging are performed by depositing lithium metal on the surface of the negative electrode and electrolytically dissolving the deposited lithium.

10. The lithium secondary battery according to claim 1, wherein the negative electrode is an electrode consisting of at least one selected from the group consisting of Cu, Ni, Ti, Fe, and other metals that do not react with Li, alloys thereof, and stainless steel (SUS).

11. The lithium secondary battery according to claim 1, wherein lithium metal is not formed on the surface of the negative electrode before initial charge.

12. The lithium secondary battery according to claim 1, wherein the battery has an energy density of 350 Wh/kg or more.

13. The lithium secondary battery according to claim 1, wherein the positive electrode comprises a positive-electrode active material.

14. The lithium secondary battery according to claim 1, wherein the conductive thin film is a thin film consisting of carbon, a thin film consisting of a metal or an alloy, or a stacked film thereof.

15. The lithium secondary battery according to claim 1, wherein a film thickness of the conductive thin film is 1 μm or less.

16. The lithium secondary battery according to claim 2, wherein an average fiber diameter of the fibrous carbon material is 2 nm or more and 500 nm or less.

17. The lithium secondary battery according to claim 2, wherein an average ratio of a fiber length to a fiber diameter of the fibrous carbon material is 20 or more and 5,000 or less.

18. The lithium secondary battery according to claim 2, wherein the fibrous carbon material is at least one selected from the group consisting of single-wall carbon nanotubes, multi-wall carbon nanotubes, and carbon nanofibers.

19. The lithium secondary battery according to claim 2, wherein a ratio of a volume occupied by the fibrous carbon material in the carbon metal composite layer is 0.1% or more and 50.0% or less.

20. The lithium secondary battery according to claim 2, wherein a thickness of the carbon metal composite layer is 5 nm or more and 5,000 nm or less.
